(19) United States
(12) Patent Application Publication
(10) Pub. No.: US 2011/0111276 A1
(43) Pub. Date: May 12, 2011

(54) ELECTRODE PLATE FOR NONAQUEOUS ELECTROLYTE SECONDARY BATTERY AND NONAQUEOUS ELECTROLYTE SECONDARY BATTERY

(76) Inventors: Toshitada Sato, Osaka (JP); Kozo Watanabe, Osaka (JP)

(21) Appl. No.: 13/002,617

(22) PCT Filed: Apr. 13, 2010
(86) PCT No.: PCT/JP2010/002663

§ 371 Date: Jan. 4, 2011

(30) Foreign Application Priority Data
May 18, 2009 (JP) 2009-119244

(51) Int. Cl. H01M 4/13; H01M 2/26

(52) U.S. Cl. 429/94; 429/211

(57) ABSTRACT

An electrode plate for a nonaqueous electrolyte secondary battery includes: a current collector made of metal foil in the shape of a band; a mixture layer containing an active material and provided on each surface of the current collector; and an extension lead connected to the current collector. The current collector has an exposed portion having first and second surfaces on each of which the mixture layer is not provided. The exposed portion extends perpendicularly to a longitudinal direction of the current collector. The extension lead is connected to the first surface of the exposed portion. A portion of the first surface on which the mixture layer is not provided has a width larger than that of a portion of the second surface on which the mixture layer is not provided.

### TECHNICAL FIELD

The present disclosure relates to electrode plates for nonaqueous electrolyte secondary batteries and nonaqueous electrolyte secondary batteries.

### BACKGROUND ART

Secondary batteries for use on automobiles and secondary batteries for large electric tools have been recently developed in consideration of environmental issues. These secondary batteries need to be capable of performing rapid charge and large-current discharge and to be small and lightweight. Examples of typical batteries satisfying such demands include a nonaqueous electrolyte secondary battery employing, as a negative electrode material, an active material such as lithium metal or a lithium alloy or a lithium intercalation compound in which lithium ions are intercalated in carbon serving as a host substance (which is herein a substance capable of intercalating or deintercalating lithium ions), and also employing, as an electrolyte, an aprotic organic solvent in which lithium salt such as LiClO₄ or LiPF₆ is dissolved.

This nonaqueous electrolyte secondary battery generally includes: a negative electrode in which the negative electrode material described above is supported on a negative electrode current collector; a positive electrode in which a positive electrode active material, e.g., lithium cobalt composite oxide, electrochemically reacting with lithium ions reversibly is supported on a positive electrode current collector; and a porous insulating layer carrying an electrolyte thereon and interposed between the negative electrode and the positive electrode to prevent short-circuit from occurring between the negative electrode and the positive electrode.

The positive and negative electrodes formed in the form of sheet or foil are stacked, or wound in a spiral, with the porous insulating layer interposed therebetween to form a power generating element. This power generating element is placed in a battery case made of metal such as stainless steel, iron plated with nickel, or aluminium. Thereafter, the electrolyte is poured in the battery case, and then a lid is fixed to the opening end of the battery case to seal the battery case. In this manner, a nonaqueous electrolyte secondary battery is fabricated.

### CITATION LIST

### Patent Document

PATENT DOCUMENT 1: Japanese Patent Publication No. 2009-64770
PATENT DOCUMENT 2: Japanese Patent Publication No. 2008-234855

### SUMMARY OF THE INVENTION

### Technical Problem

In a nonaqueous electrolyte secondary battery (which may be hereinafter simply referred to as a “battery”), as a means for increasing the capacity, the densities of positive and negative electrodes are increased. In the case of employing this means, electrode plates in both of the positive and negative electrodes tend to become hard.

In addition, with an increase in the capacity, the energy density as a battery increases, and thus, it is important to ensure the safety. As a safety test, a mechanical stress is applied to a battery to crush the battery in order to simulate a situation in which a battery pack is pressed by a heavy object such as an automobile. In this crush test, in a battery having an increased capacity and using hard electrode plates as described above, the electrode plate of one of the electrodes might bend to be broken under a pressure, and penetrate a separator to come into contact with the other electrode, resulting in a short-circuit, and further, heat generation.

It is therefore an object of the present disclosure to provide an electrode plate for a nonaqueous electrolyte secondary battery capable of preventing a short-circuit caused by crush, while maintaining a large capacity and a high energy density of the battery.

### Solution to the Problem

To achieve the object, an electrode plate for a nonaqueous electrolyte secondary battery according to the present disclosure includes: a current collector made of metal foil in the shape of a band; a mixture layer containing an active material and provided on each surface of the current collector; and an extension lead connected to the current collector, wherein the current collector has an exposed portion having first and second surfaces on each of which the mixture layer is not provided, the exposed portion extends perpendicularly to a longitudinal direction of the current collector, the extension lead is connected to the first surface of the exposed portion, and a portion of the first surface on which the mixture layer is not provided has a width larger than that of a portion of the second surface on which the mixture layer is not provided.

In the electrode plate, two ends of the mixture layer facing the exposed portion on the second surface may be located at positions corresponding to positions on the first surface on which the exposed portion is not provided.

In the electrode plate, a portion of the second surface on which the mixture layer is not provided may have a width smaller than that of the extension lead vertical to the longitudinal direction of the current collector. In this structure, two ends of the mixture layer facing the exposed portion on the second surface may be located at positions corresponding to positions on the first surface on which the extension lead is provided.

A nonaqueous electrolyte secondary battery according to the present disclosure includes an electrode case enclosing a nonaqueous electrolyte and an electrode group in which a positive electrode plate and a negative electrode plate are wound with a porous insulating layer interposed therebetween, wherein at least one of the positive electrode plate and the negative electrode plate is the electrode plate described above.

In the electrode plate, the current collector may be aluminium foil, and the active material may be a positive electrode active material.

### ADVANTAGES OF THE INVENTION

In an electrode plate for a nonaqueous electrolyte secondary battery and a nonaqueous electrolyte secondary battery according to the present disclosure, a portion of one surface (i.e., a first surface) of an exposed portion on which no mixture layer is provided has a width larger than that of a portion of the other surface (i.e., a second surface) of the exposed portion on which no mixture layer is provided. Accordingly, a short-circuit does not easily occur even when the battery is crushed. As a result, the safety of the battery can be significantly enhanced.

### BRIEF DESCRIPTION OF THE DRAWINGS

FIG. 1 is a vertical cross-sectional view schematically illustrating a structure of a nonaqueous electrolyte secondary battery according to an embodiment.

FIG. 2 is an enlarged cross-sectional view schematically illustrating a structure of an electrode group.

FIG. 3 is an enlarged cross-sectional view schematically illustrating a structure of a position to which a lead is attached in a comparative embodiment.

FIG. 4 is an enlarged cross-sectional view schematically illustrating a structure of a position to which a lead is attached in an embodiment.

FIG. 5 is an enlarged cross-sectional view schematically illustrating a structure of a position to which a lead is attached in another embodiment.

### DESCRIPTION OF EMBODIMENTS

Prior to description of an embodiment of the present disclosure, it will be described how the present disclosure was achieved.

As described above, in a crush test in which a mechanical stress is applied to a nonaqueous electrolyte secondary battery with increased densities of positive and negative electrodes so that the battery is crushed, an electrode plate is bent to be broken under a pressure, penetrates a separator, and as a result, causes a short-circuit in some cases. To solve this problem, as described in Patent Document 1, the technique of increasing the flexibility of the electrode plates themselves is proposed.

However, it was found that even with the technique described in Patent Document 1, when a stronger stress is applied to the battery to crush the battery, heat generation might occur. A detailed study on this problem shows that a lead connection portion of an electrode plate has a large thickness difference at the boundary between a portion coated with an active material and an uncoated portion (i.e., the lead connection portion) and easily bends. Accordingly, the electrode plate bends at an acute angle at this boundary, and this bending portion penetrates the separator to cause a short-circuit.

In particular, in the case where a lead is connected to a middle portion of an electrode plate in the length direction thereof described in Patent Document 2, the lead volume with respect to the internal volume of the battery can be minimized, and the current collection resistance of the electrode plate can be reduced. On the other hand, in this case, when an external force is applied, the presence of the lead in the middle portion tends to cause a stress as described above to concentrate on a portion near the lead. This problem, however, is not pointed out in Patent Document 2.

The inventors of the present disclosure carried out various attempts to solve the above-described problems, and eventually achieved the present disclosure.

An embodiment of the present disclosure will be described hereinafter with reference to the drawings. It should be noted that the present disclosure is not limited to the following embodiment.

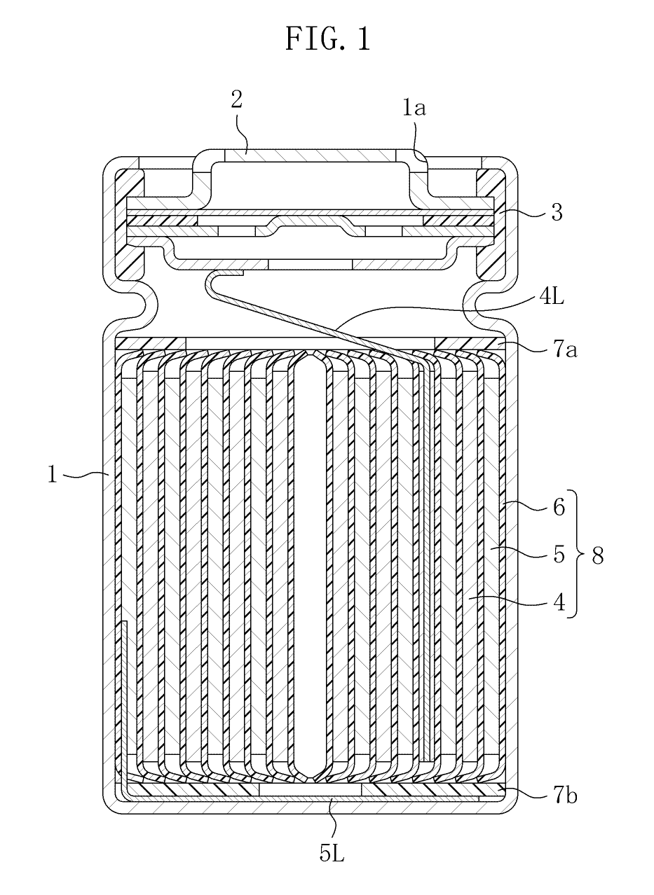

A structure of a lithium ion secondary battery as an example of a nonaqueous electrolyte secondary battery according to the embodiment will be described with reference to FIG. 1. FIG. 1 is a vertical cross-sectional view illustrating a structure of a nonaqueous electrolyte secondary battery according to the embodiment.

As illustrated in FIG. 1, the nonaqueous electrolyte secondary battery of this embodiment includes a battery case 1 made of, for example, iron (coated with nickel plating) and an electrode group 8 housed in the battery case 1.

An opening 1a is formed in the upper surface of the battery case 1. A sealing plate 2 is crimped to the opening 1a with a gasket 3 interposed therebetween, thereby sealing the opening 1a.

The electrode group 8 includes: a positive electrode plate 4; a negative electrode plate 5; and a porous insulating layer (i.e., a separator) 6 made of, for example, polyethylene. The positive electrode plate 4 and the negative electrode plate 5 are wound a spiral with the separator 6 interposed therebetween. An upper insulating plate 7a is placed on top of the electrode group 8. A lower insulating plate 7b is placed on the bottom of the electrode group 8.

An end of a positive electrode lead (i.e., an extension lead for the positive electrode) 4L made of aluminium is attached to the positive electrode plate 4, and the other end of the positive electrode lead 4L is connected to the sealing plate 2 also serving as a positive electrode terminal. An end of a negative electrode lead (i.e., an extension lead for the negative electrode) 5L made of nickel is attached to the negative electrode plate 5, and the other end of the negative electrode lead 5L is connected to the battery case 1 also serving as a negative electrode terminal.

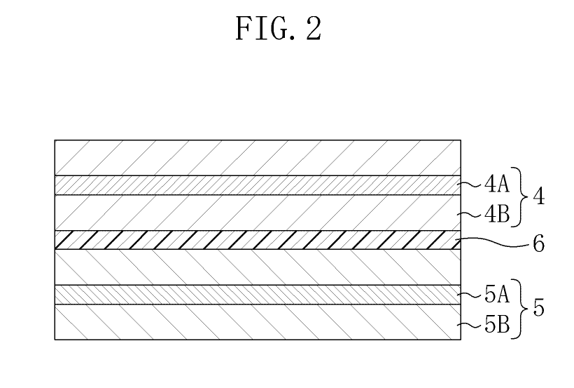

A structure of the electrode group 8 forming the nonaqueous electrolyte secondary battery of this embodiment will be described hereinafter with reference to FIG. 2. FIG. 2 is an enlarged cross-sectional view illustrating a structure of the electrode group 8.

As illustrated in FIG. 2, the positive electrode plate 4 includes a positive electrode current collector 4A and a positive electrode material mixture layer 4B. The positive electrode current collector 4A is in the shape of a band, and is a conductive foil member. Specifically, the positive electrode current collector 4A is made of a member mainly containing aluminium. The positive electrode material mixture layer 4B is provided on each surface of the positive electrode current collector 4A, contains a positive electrode active material (e.g., lithium composite oxide) and a binder, and preferably contains a conductive agent, for example.

As illustrated in FIG. 2, the negative electrode plate 5 includes a negative electrode current collector 5A and a negative electrode material mixture layer 5B. The negative electrode current collector 5A is in the shape of a band, and is a conductive foil member. The negative electrode material mixture layer 5B is provided on each surface of the negative electrode current collector 5A, and contains a negative electrode active material. The negative electrode material mixture layer 5B preferably contains a binder in addition to the negative electrode active material.

As illustrated in FIG. 2, the separator 6 is interposed between the positive electrode plate 4 and the negative electrode plate 5.

In a portion of at least one of the positive electrode plate 4 and the negative electrode plate 5 to which the lead is connected, the mixture layer is not formed on one surface of the current collector connected to the lead (i.e., a first surface) and on the other surface (i.e., a second surface) of the current collector. This portion which is not provided with the mixture layer will be hereinafter referred to as an exposed portion. The exposed portion extends perpendicularly to the length direction of the positive electrode plate 4 or the negative electrode plate 5 in the shape of a band. The exposed portion of the positive electrode plate 4 or the negative electrode plate 5 is located on a trench formed in the positive electrode plate 4 or the negative electrode plate 5. Specifically, the bottom of this trench is the exposed portion. A structure in which only the surface of the current collector connected to the lead (i.e., the first surface) is exposed and the mixture layer is formed on the other surface (i.e., the second surface), is not preferable because the mixture layer on the other surface (i.e., the second surface) is peeled off from the other surface (i.e., the second surface) when the lead is connected to the current collector by, for example, welding.

In contrast, in this embodiment, the width of a no-mixture-layer formed portion of the surface connected to the lead is larger than the width of a no-mixture-layer formed portion of the other surface. In this structure, the no-mixture-layer formed portion of the surface opposite to the surface connected to the lead has two ends (each of which is the boundary between a portion provided with the mixture layer and a portion not provided with the mixture layer) in the longitudinal direction of the current collector. Both of these two ends are preferably located at positions corresponding to positions on the opposite surface (i.e., the surface connected to the lead) where the mixture layer is not provided. The width of the no-mixture-layer portion of the surface opposite to the surface connected to the lead is preferably smaller than that of the lead.

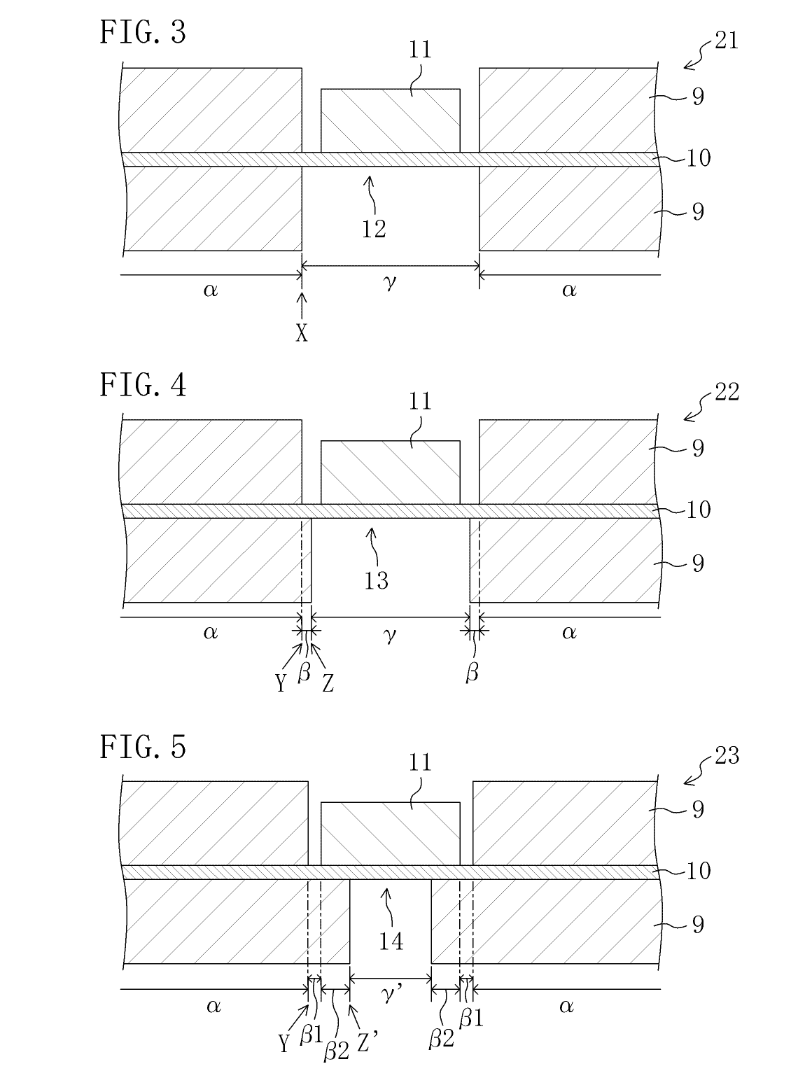

FIG. 3 is a cross-sectional view schematically illustrating an electrode plate 21 according to a comparative embodiment. FIG. 4 is a cross-sectional view schematically illustrating an electrode plate 22 according to this embodiment. FIG. 5 is a cross-sectional view schematically illustrating another electrode plate 23 according to the embodiment. These cross-sectional views are taken along the longitudinal directions of the electrode plates 21, 22, and 23.

In the electrode plate 21 of the comparative embodiment illustrated in FIG. 3, both-surface coated portions a in each of which the mixture layer 9 is formed on each of both surfaces of the current collector 10, are respectively provided at both ends of a both-surface uncoated portion γ of the current collector 10 in each of which the mixture layer 9 is not formed on each of both surfaces of the current collector 10, in the longitudinal direction of the current collector 10. A portion of the current collector 10 located in the both-surface uncoated portion γ is an exposed portion 12 whose both surfaces are exposed, and the extension lead 11 is connected to one of the surfaces of the exposed portion 12. The boundary between a portion provided with the mixture layer 9 and a portion not provided with the mixture layer 9 is located at the same positions on both surfaces of the current collector 10, and is referred to as a boundary X between the both-surface uncoated portion γ and each of the both-surface coated portions α. In this structure, when a stress is applied to the electrode plate 21 in or after winding of the electrode plate 21 together with the separator 6, a large difference in the thickness of the electrode plate 21 at the boundaries X causes the stress to concentrate on the boundaries X. Suppose the thickness of the mixture layer 9 is Ta (corresponding to one layer) and the thickness of the current collector 10 is Tb, the thickness at the boundaries X changes from (2Ta+Tb) to Tb. The amount of this change is twice as large as the thickness of the mixture layer 9, and is equal to about 70-95% of the thickness of the electrode plate 21. Consequently, the electrode plate 21 might bend at an acute angle at the boundaries X to damage the separator 6 and cause a short-circuit.

On the other hand, in the electrode plate 22 of this embodiment illustrated in FIG. 4, the width (in the longitudinal direction of the current collector) of a portion where the mixture layer 9 is not provided on the surface (i.e., the first surface) of the current collector 10 connected to the extension lead 11 is larger than the width (in the longitudinal direction of the current collector) of a portion where the mixture layer 9 is not provided on the other surface (i.e., the second surface: the surface opposite to the surface of the current collector 10 connected to the extension lead 11) of the current collector 10. In the electrode plate 22 with this structure, single-surface coated portions β are respectively located adjacent to the both-surface coated portions α, and the both-surface uncoated portion γ is located adjacent to the single-surface coated portions β. In the single-surface coated portions β, the mixture layer 9 is not provided on one surface of the current collector 10, but is provided on the other surface of the current collector 10. In this structure, the thickness of the electrode plate 22 in the longitudinal direction thereof changes from (2Ta+Tb) to (Ta+Tb) at boundaries Y between the both-surface coated portions α and the single-surface coated portions β. The amount of this change in thickness is equal to the thickness of the mixture layer 9. The thickness changes from (Ta+Tb) to Tb at the boundaries Z between the single-surface coated portions and the both-surface uncoated portion γ. The amount of this change is also equal to the thickness of the mixture layer 9. Accordingly, as compared to the comparative embodiment illustrated in FIG. 3, a stress induced by bending of the electrode plate 22 of this embodiment is dispersed between the boundaries Y and boundaries Z, and the amount of change in thickness at the boundaries Y and Z is smaller than that in the comparative embodiment. Thus, it is expected that the electrode plate 22 does not easily bend at an acute angle, thereby reducing the possibility of damage on the separator 6.

In another electrode plate 23 of this embodiment illustrated in FIG. 5, the width of a portion where the mixture layer 9 is not provided on the surface of the current collector 10 not connected to the lead is smaller than that in the electrode plate 22 illustrated in FIG. 4. In addition, in FIG. 5, the extension lead 11 is located on the surface (i.e., the second surface) of the current collector 10 not connected to the lead at the boundaries Z′ between a both-surface uncoated portion γ′ and single-surface coated portions β2. Accordingly, this structure includes two types of single-surface coated portions β1 and β2: the single-surface coated portions β32 where the extension lead 11 is provided and the single-surface coated portions β1 where the extension lead 11 is not provided, on the surface of the current collector 10 not connected to the lead. Consequently, the boundaries Z′ between the both-surface uncoated portion γ′ and the single-surface coated portions β2 are expected to have higher durability to a bending stress than the boundaries Z shown in FIG. 4. As a result, it is expected that the electrode plate 23 does not easily bend at an acute angle to further reduce damage on the separator 6, thereby preventing occurrence of a short-circuit. In connecting the extension lead 11 to the current collector 10, a middle portion of the extension lead 11 in the width direction thereof is connected to the current collector 10 by, for example, welding. Thus, as illustrated in FIG. 5, even in the structure in which the mixture layer 9 is provided on the surface of the current collector 10 not connected to the lead, at an end of the extension lead 11 in the width direction of the extension lead 11, the welding, for example, does not affect this portion, and the mixture layer 9 is not peeled off.

A structure in which the width (in the longitudinal direction of the current collector 10) of a portion where the mixture layer 9 is not provided on one surface of the current collector 10 connected to the extension lead 11 is smaller than the width of a portion where the mixture layer 9 is not provided on the other surface of the current collector 10, as opposed to the structure illustrated in FIGS. 4 and 5, also has high durability to the bending stress, as in the structures of FIGS. 4 and 5. However, the current-collector exposed surface opposite to the surface connected to the extension lead 11 only needs to have an opening in a portion necessary for the connection, and unnecessary extension of the opening leads to a decrease in the amount of the active material, i.e., a decrease in the battery capacity.

In view of the above consideration, the width of the no-mixture-layer portion on the surface connected to the lead is preferably larger than that of the no-mixture-layer portion on the surface opposite the surface connected to the lead.

The positive electrode plate 4, the negative electrode plate 5, the separator 6, and the nonaqueous electrolyte forming the nonaqueous electrolyte secondary battery of this embodiment will be described in detail hereinafter.

First, the positive electrode plate is described in detail.

—Positive Electrode Plate—

The positive electrode current collector 4A and the positive electrode material mixture layer 4B forming the positive electrode plate 4 will now be described in order.

As the positive electrode current collector 4A, a long porous conductive substrate or a long non-porous conductive substrate is used. As the positive electrode current collector 4A, metal foil mainly containing aluminium is used. Although not specifically limited, the thickness of the positive electrode current collector 4A is preferably in the range from 1 μm to 500 μm, both inclusive, and more preferably in the range from 10 μm to 20 μm, both inclusive. Setting the thickness of the positive electrode current collector 4A in the above range can reduce the weight of the positive electrode 4, while maintaining the strength of the positive electrode 4. In particular, in this present disclosure, the degree of extension (i.e., elongation at break) of the positive electrode current collector 4A is preferably 3% or more. To achieve an extension degree of 3% or more, it is preferable to apply a predetermined amount of heat to the positive electrode plate 4 or to perform heat treatment before formation of the positive electrode material mixture layer 4B, for example. A preferred example of the composition of the positive electrode current collector 4A for achieving the above-mentioned degree of extension is, for example, a composition in which iron in the range from 1.0 percent by mass (mass %) to 2.0 mass %, both inclusive, is added to aluminium. The use of the positive electrode current collector 4A with such a composition can achieve the above-mentioned degree of extension at a temperature at which the binder and the positive electrode active material contained in the positive electrode material mixture layer 4B is not easily degraded by heat.

Next, the positive electrode active material, the binder, and the conductive agent contained in the positive electrode material mixture layer 4B will now be described in order.

<Positive Electrode Active Material>

Examples of the positive electrode active material include LiCoO₂, LiMnO₂, LiCoNiO₂, LiCoMO_{z}, LiNiMO_{z}, LiNi_{1/3}Co_{1/3}Mn_{1/3}O₂, LiMn₂O₄, LiMnMO₄, LiMePO₄, and Li₂MePO₄F (where M is at least one of Na, Mg, Sc, Y, Mn, Fe, Co, Ni, Cu, Zn, Al, Cr, Pb, Sb, and B, and Me is a metal element containing at least one selected from the group consisting of Fe, Mn, Co, and Ni), and also include materials in each of which part of the element of one of the lithium-containing compounds listed above is partially substituted with an element of a different type. In addition, the positive electrode active material may be a positive electrode active material subjected to a surface process using a metal oxide, a lithium oxide, or a conductive agent, for example. Examples of this surface process include hydrophobization.

The positive electrode active material preferably has an average particle diameter in the range from 5 μm to 20 μm, both inclusive.

If the average particle diameter of the positive electrode active material is less than 5 μm, the surface area of the active material particles is extremely large, and the amount of the binder satisfying the bonding strength necessary for sufficiently enabling handling of the positive electrode plate is extremely large. Thus, the amount of the active material in the electrode plate decreases, thereby reducing the capacity. On the other hand, if the average particle diameter of the positive electrode active material exceeds 20 μm, a coating streak is likely to occur in coating the positive electrode current collector with the positive electrode material mixture slurry. For this reason, the average particle diameter of the positive electrode active material is preferably in the range from 5 μm to 20 μm, both inclusive.

<Binder>

Examples of the binder include polyvinylidene fluoride (PVDF), polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyether sulphone, hexafluoropolypropylene, styrene-butadiene rubber, and carboxymethyl cellulose. Examples of the binder also include a copolymer of two or more materials selected from the group consisting of tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid, and hexadiene, and a mixture of two or more materials selected from these materials.

Among the materials for the binder listed above, PVDF and a derivative thereof are particularly chemically stable in the nonaqueous electrolyte secondary battery, and can sufficiently bond the positive electrode material mixture layer 4B and the positive electrode current collector 4A together, and also sufficiently bond the positive electrode active material, the binder, and the conductive agent forming the positive electrode material mixture layer 4B, thereby obtaining excellent cycle characteristics and discharge performance. For this reason, PVDF or a derivative thereof is preferably used as the binder of the present disclosure. In addition, PVDF and a derivative thereof are not expensive, and thus are preferable. To form a positive electrode using PVDF as a binder, PVDF is dissolved in N-methylpyrrolidone or powdery PVDF is dissolved in positive electrode material mixture slurry, for example, in forming the positive electrode.

<Conductive Agent>

Examples of the conductive agent include graphites such as natural graphite and artificial graphite, carbon blacks such as acetylene black (AB), Ketjen black, channel black, furnace black, lamp black, and thermal black, conductive fibers such as carbon fiber and metal fiber, metal powders such as carbon fluoride and aluminium, conductive whiskers such as zinc oxide and potassium titanate, conductive metal oxides such as titanium oxide, and organic conductive materials such as a phenylene derivative.

Then, the negative electrode plate is described in detail.

—Negative Electrode Plate—

The negative electrode current collector 5A and the negative electrode material mixture layer 5B forming the negative electrode plate 5 will now be described in order.

As the negative electrode current collector 5A, a long porous conductive substrate or a long non-porous conductive substrate is used. The negative electrode current collector 5A is made of, for example, stainless steel, nickel, or copper. Although not specifically limited, the thickness of the negative electrode current collector 5A is preferably in the range from 1 μm to 500 μm, both inclusive, and more preferably in the range from 10 μm to 20 μm, both inclusive. Setting the thickness of the negative electrode current collector 5A in the above range can reduce the weight of the negative electrode 5, while maintaining the strength of the negative electrode 5.

The negative electrode material mixture layer 5B preferably contains a binder in addition to the negative electrode active material.

The negative electrode active material contained in the negative electrode material mixture layer 5B will be described hereinafter.

<Negative Electrode Active Material>

Example of the negative electrode active material include metal, metal fiber, a carbon material, oxide, nitride, a silicon compound, a tin compound, and various alloys. Examples of the carbon material include various natural graphites, coke, partially-graphitized carbon, carbon fiber, spherical carbon, various artificial graphites, and amorphous carbon.

Since simple substances such as silicon (Si) and tin (Sn), silicon compounds, and tin compounds have high capacitance densities, it is preferable to use silicon, tin, a silicon compound, or a tin compound, for example, as the negative electrode active material. Examples of the silicon compound include SiOₓ (where 0.05<x<1.95) and a silicon alloy and a silicon solid solution obtained by substituting part of Si with at least one of the elements selected from the group consisting of B, Mg, Ni, Ti, Mo, Co, Ca, Cr, Cu, Fe, Mn, Nb, Ta, V, W, Zn, C, N, and Sn. Examples of the tin compound include Ni₂Sn₄, Mg₂Sn, SnOₓ (where 0<x<2), Sno₂, and SnSiO₃. One of the examples of the negative electrode active material may be used solely or two or more of them may be used in combination.

Further, a negative electrode in which a thin film of silicon, tin, a silicon compound, or a tin compound described above is deposited on a negative electrode current collector 5A may be used.

Then, the separator is described in detail.

—Separator—

Examples of the separator 6 interposed between the positive electrode plate 4 and the negative electrode plate 5 include a microporous thin film, woven fabric, and nonwoven fabric each of which has a high ion permeability, a predetermined mechanical strength, and a predetermined insulation property. In particular, polyolefin such as polypropylene or polyethylene is preferably used as the separator 6. This is because polyolefin has high durability and a shutdown function, and thus, the safety of the lithium ion secondary battery can be enhanced. The thickness of the separator 6 is generally in the range from 10 μm to 300 μm, both inclusive, and preferably in the range from 10 μm to 40 μm, both inclusive. The thickness of the separator 6 is more preferably in the range from 10 μm to 25 μm, both inclusive. In the case of using a microporous thin film as the separator 6, this microporous thin film may be a single-layer film made of a material of one type, or may be a composite film or a multilayer film made of one or more types of materials. The porosity of the separator 6 is preferably in the range from 30% to 70%, both inclusive, and more preferably in the range from 35% to 60%, both inclusive. The “porosity” herein is the volume ratio of pores to the total volume of the separator.

Then, the nonaqueous electrolyte is described in detail.

—Nonaqueous Electrolyte—

The nonaqueous electrolyte may be a liquid nonaqueous electrolyte, a gelled nonaqueous electrolyte, or a solid nonaqueous electrolyte.

The liquid nonaqueous electrolyte (i.e., the nonaqueous electrolyte) contains an electrolyte (e.g., lithium salt) and a nonaqueous solvent in which this electrolyte is to be dissolved.

The gelled nonaqueous electrolyte contains an nonaqueous electrolyte and a polymer material supporting the nonaqueous electrolyte. Examples of this polymer material include polyvinylidene fluoride, polyacrylonitrile, polyethylene oxide, polyvinyl chloride, polyacrylate, and polyvinylidene fluoride hexafluoropropylene.

The solid nonaqueous electrolyte contains a solid polymer electrolyte.

The nonaqueous electrolyte is described in detail.

As a nonaqueous solvent in which an electrolyte is to be dissolved, a known nonaqueous solvent may be used. The type of this nonaqueous solvent is not specifically limited, and examples of the nonaqueous solvent include cyclic carbonic ester, chain carbonic ester, and cyclic carboxylate ester. Cyclic carbonic ester may be propylene carbonate (PC) or ethylene carbonate (EC), for example. Chain carbonic ester may be diethyl carbonate (DEC), ethylmethyl carbonate (EMC), or dimethyl carbonate (DMC), for example. Cyclic carboxylate ester may be γ-butyrolactone (GBL) or γ-valerolactone (GVL), for example. One of the examples of the nonaqueous solvent may be used solely or two or more of them may be used in combination.

Examples of the electrolyte to be dissolved in the nonaqueous solvent include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylate, LiCl, LiBr, LiI, chloroborane lithium, borates, and imidates. Examples of the borates include bis(1,2-benzene diorate(2-)—O,O′)lithium borate, bis(2,3-naphthalene diorate(2-)—O,O′)lithium borate, bis(2,2′-biphenyl diorate(2-)—O,O′)lithium borate, and bis(5-fluoro-2-orate-1-benzenesulfonic acid-O,O′)lithium borate. Examples of the imidates include lithium bistrifluoromethanesulfonimide ((CF₃SO₂)₂NLi), lithium trifluoromethanesulfonate nonafluorobutanesulfonimide (LiN(CF₃SO₂)(C₄F₉SO₂)), and lithium bispentafluoroethanesulfonimide ((C₂F₅SO₂)₂NLi). One of these electrolytes may be used solely or two or more of them may be used in combination.

The amount of the electrolyte dissolved in the nonaqueous solvent is preferably in the range from 0.5 mol/m³ to 2 mol/m³, both inclusive.

The nonaqueous electrolyte may contain an additive which is decomposed on the negative electrode and forms thereon a coating having high lithium ion conductivity to enhance the charge/discharge efficiency of the battery, for example, in addition to the electrolyte and the nonaqueous solvent. Examples of the additive include vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinyl ethylene carbonate (VEC), and divinyl ethylene carbonate. As the additive, one of the materials listed above may be used solely or two or more of them may be used in combination. Among the materials listed above, at least one selected from the group consisting of vinylene carbonate, vinyl ethylene carbonate, and divinyl ethylene carbonate is preferably contained. In the above-listed materials for the additive, hydrogen atoms may be partially substituted with fluorine atoms.

The nonaqueous electrolyte may further contain, for example, a known benzene derivative which is decomposed during overcharge and forms a coating on the electrode to inactivate the battery, in addition to the electrolyte and the nonaqueous solvent. The benzene derivative having such a function preferably includes a phenyl group and a cyclic compound group adjacent to the phenyl group. Examples of the benzene derivative include cyclohexylbenzene, biphenyl, and diphenyl ether. Examples of the cyclic compound group included in the benzene derivative include a phenyl group, a cyclic ether group, a cyclic ester group, a cycloalkyl group, and a phenoxy group. As the benzene derivative, one of the materials listed above may be used solely or two or more of them may be used in combination. However, the content of the benzene derivative in the nonaqueous solvent is preferably 10 volume percent (vol. %) or less of the total volume of the nonaqueous solvent.

The structure of the nonaqueous electrolyte secondary battery of this embodiment is not limited to the structure illustrated in FIG. 1. For example, the nonaqueous electrolyte secondary battery of this embodiment is not limited to a cylindrical battery as illustrated in FIG. 1, and a rectangular battery or a high-power battery may be employed. In addition, the embodiment is not limited to the electrode group 8 in which the positive electrode 4 and the negative electrode 5 are wound in a spiral with the separator 6 interposed therebetween as illustrated in FIG. 1. Alternatively, an electrode group in which a positive electrode and a negative electrode are stacked with a separator interposed therebetween may be employed.

A method for fabricating a lithium ion secondary battery as an example of a nonaqueous electrolyte secondary battery according to the embodiment will be described with reference to FIG. 1.

A method for forming a positive electrode plate 4, a method for forming a negative electrode plate 5, and a method for fabricating a battery will now be described in order.

—Method for Forming Positive Electrode Plate—

A positive electrode plate 4 is formed in the following manner. For example, first, a positive electrode active material, a binder (which is preferably made of PVDF, a derivative thereof, or a rubber-based binder as described above), and a conductive agent are mixed in a liquid component, thereby preparing positive electrode material mixture slurry. Then, this positive electrode material mixture slurry is applied onto the surface of a positive electrode current collector 4A made of foil mainly containing aluminium, and the slurry is dried. Thereafter, the resultant positive electrode current collector 4A is rolled, thereby forming a positive electrode having a predetermined thickness. Subsequently, the positive electrode plate 4 is subjected to heat treatment, thereby obtaining a high degree of extension. For example, the positive electrode plate 4 may be placed in a furnace in a nitrogen atmosphere and then is taken out after a lapse of a predetermined time, or the positive electrode plate 4 with a hoop shape may be brought into contact with the surface of a previously-heated roll while the roll is passed through the positive electrode plate 4, for example. In this manner, the positive electrode plate 4 with a high degree of extension of 3% or more can be obtained.

The amount of the binder contained in the positive electrode material mixture slurry is preferably in the range from 1.0 volume percent (vol. %) to 6.0 vol. %, both inclusive, with respect to 100.0 vol. % of the positive electrode active material. In other words, the amount of the binder contained in the positive electrode material mixture layer is preferably in the range from 1.0 vol. % to 6.0 vol. %, both inclusive, with respect to 100.0 vol. % of the positive electrode active material.

—Method for Forming Negative Electrode Plate—

A negative electrode plate 5 is formed in the following manner. For example, first, a negative electrode active material and a binder are mixed in a liquid component, thereby preparing negative electrode material mixture slurry. Then, this negative electrode material mixture slurry is applied onto the surface of a negative electrode current collector 5A, and the slurry is dried. Thereafter, the resultant negative electrode current collector 5A is rolled, thereby forming a negative electrode having a predetermined thickness.

—Attachment of Lead—

A lead is connected in order to take current and voltage from the positive electrode plate 4 and the negative electrode plate 5. In this connection, a portion of the current collector to which the lead is attached needs to be exposed beforehand.

The position of attachment of the lead in the present disclosure is not specifically limited. Suppose in the length direction of the electrode plate, the start point is 0 (zero), the end point is 1 (one), and 0 (zero) is the start end of winding of the electrode group, this lead attachment position is preferably located in the range from ¼ to ¾. With this structure, the internal volume can be effectively utilized, and sufficient current collection can be achieved. This structure is effective especially for a cylindrical battery. It is sufficient that at least one of the positive electrode and the negative electrode satisfies the above conditions for the lead attachment position. The other lead is preferably attached to a position at which a short-circuit between the leads does not easily occur and a battery is easily fabricated, in terms of the structure of the battery. For example, in a cylindrical battery, if the positive electrode lead is attached to a portion near a middle potion in the length direction of the electrode plate, the negative electrode lead is preferably located near the outermost portion of the negative electrode in terms of the battery structure.

The lead connection portion may be exposed by the technique (i.e., a die coater) of performing coating with an active material mixture not formed beforehand on the portion to be exposed beforehand or the technique of performing coating and then peeling a portion to be exposed.

<Method for Fabricating Battery>

A battery is fabricated in the following manner. For example, first, as illustrated in FIG. 1, an aluminium positive electrode lead 4L is attached to a positive electrode current collector (see, 4A in FIG. 2), and a nickel negative electrode lead 5L is attached to a negative electrode current collector (see, 5A in FIG. 2). Then, the positive electrode plate 4 and the negative electrode plate 5 are wound with the separator 6 interposed therebetween, thereby forming an electrode group 8. Thereafter, an upper insulating plate 7a is placed on the upper end of the electrode group 8, and a lower insulating plate 7b is placed on the lower end of the electrode group 8. Subsequently, the negative electrode lead 5L is welded to a battery case 1, and the positive electrode lead 4L is welded to a sealing plate 2 including a safety valve which operates with internal pressure, thereby housing the electrode group 8 in the battery case 1. Then, a nonaqueous electrolyte is poured in the battery case 1. Lastly, an opening end of the battery case 1 is crimped to the sealing plate 2 with a gasket 3 interposed therebetween. In this manner, a battery is fabricated.

Examples will be described in detail hereinafter.

### Example 1 and Comparative Example 1

Batteries 1-4 as Example 1 and batteries 5-7 as Comparative Example 1 were fabricated.

A method for fabricating the battery 1 will be described in detail hereinafter.

(Battery 1)

(Formation of Positive Electrode Plate)

First, as a positive electrode active material, LiNi_{0.82}CO_{0.15}Al_{0.03}O₂ with an average particle diameter of 10 μm was prepared.

Next, 4.5 vol. % of acetylene black as a conductive agent with respect to 100.0 vol. % of the positive electrode active material, a solution in which 4.7 vol. % of polyvinylidene fluoride (PVDF) as a binder with respect to 100.0 vol. % of the positive electrode active material was dissolved in a N-methylpyrrolidone (NMP) solvent, and LiNi_{0.82}CO_{0.15}Al_{0.03}O₂ were mixed, thereby obtaining positive electrode material mixture slurry. This positive electrode material mixture slurry was applied onto both surfaces of aluminium foil with a thickness of 15 μm as a positive electrode current collector, and the slurry was dried, thereby obtaining a positive electrode material mixture layer. Thereafter, the resultant positive electrode current collector whose both surfaces were coated with the dried positive electrode material mixture slurry was rolled, thereby obtaining a positive electrode plate prototype in the shape of a plate having a thickness of 0.157 mm. This positive electrode plate prototype was placed in a furnace previously heated to 260° C. and set in a nitrogen atmosphere, and was taken out after a lapse of two hours. The degree of extension of the positive electrode plate prototype after this heat treatment was 3.5%. This positive electrode plate prototype was cut to have a width of 57 mm and a length of 564 mm, thereby obtaining a positive electrode plate having a thickness of 0.157 mm, a width of 57 mm, and a length of 564 mm.

(Formation of Negative Electrode Plate)

First, flake artificial graphite was ground and classified to have an average particle diameter of about 20 μm.

Then, 3 parts by weight (pbw) of styrene butadiene rubber as a binder and 100 pbw of a solution containing 1 weight percent (wt. %) of carboxymethyl cellulose were added to 100 pbw of flake artificial graphite as a negative electrode active material, and these materials were mixed, thereby obtaining negative electrode material mixture slurry. This negative electrode material mixture slurry was then applied onto both surfaces of copper foil with a thickness of 8 μm as a negative electrode current collector, and the slurry was dried, thereby obtaining a negative electrode material mixture layer. Thereafter, the resultant negative electrode current collector whose both surfaces were coated with the dried negative electrode material mixture slurry was rolled, thereby obtaining a negative electrode plate prototype having a thickness of 0.156 mm. This negative electrode plate prototype was subjected to heat treatment in a nitrogen atmosphere at 190° C. for 8 hours. The negative electrode plate prototype was then cut to have a width of 58.5 mm and a length of 750 mm, thereby obtaining a negative electrode plate with a thickness of 0.156 mm, a width of 58.5 mm, and a length of 750 mm.

(Preparation of Nonaqueous Electrolyte)

To a solvent mixture of ethylene carbonate and dimethyl carbonate in the volume ratio of 1:3 as a nonaqueous solvent, 5 wt. % of vinylene carbonate was added as an additive for increasing the charge/discharge efficiency of the battery, and LiPF₆ as an electrolyte was dissolved in a mole concentration of 1.4 mol/dm³ with respect to the nonaqueous solvent, thereby obtaining a nonaqueous electrolyte.

(Fabrication of Cylindrical Battery)

In the positive electrode plate described above, the positive electrode material mixture layer was peeled off from the surface of the positive electrode current collector connected to the lead such that a portion where the positive electrode current collector was exposed had a width of 8 mm from the position of 278 mm to the position of 286 mm in the length direction relative to the end and that the positive electrode material mixture layer was peeled off from the surface of the positive electrode current collector opposite to the surface thereof connected to the lead a portion such that a portion the positive electrode current collector was exposed had a width of 2 mm from the position of 281 mm to the position of 283 mm. In the negative electrode plate, the position connected to the lead was located at the outermost portion of the negative electrode plate. The surface where the lead connection portion was exposed in the negative electrode plate was located at the end (i.e., the outermost portion) thereof. In this structure, the other surface of the lead connection portion opposite to the exposed surface thereof was also coated with no mixture layer (i.e., was also exposed).

An aluminium positive electrode lead (with a width of 6 mm) was attached to the lead connection surface from which the mixture layer of the positive electrode current collector had been peeled off, and a nickel negative electrode lead (with a width of 4 mm) was attached to the negative electrode current collector. The positive electrode lead was attached by ultrasonic welding. The negative electrode lead was attached by resistance welding.

After the attachment of the leads to the electrodes, the leads were protected and insulated by a polypropylene adhesive tape with a width of 8 mm in the positive electrode plate and by a polyethylene adhesive tape in the negative electrode plate. Thereafter, the positive electrode plate and the negative electrode plate were wound with a polyethylene separator interposed therebetween, thereby forming an electrode group. Thereafter, an upper insulating plate was placed on the upper end of the electrode group, and a lower insulating plate was placed on the lower end of the electrode group. Subsequently, the negative electrode lead was welded to a battery case, and the positive electrode lead was welded to a sealing plate including a safety valve which operates with internal pressure, thereby housing the electrode group in the battery case. Then, a nonaqueous electrolyte was poured in the battery case under a reduced pressure. Lastly, an opening end of the battery case was crimped to the sealing plate with a gasket interposed therebetween. In this manner, a battery 1 was fabricated.

(Battery 2)

A battery 2 was fabricated in the same manner as the battery 1 except that the positive electrode material mixture layer was peeled off from the surface of the positive electrode current collector opposite to the surface thereof connected to the lead such that a portion where the positive electrode current collector was exposed had a width of 1 mm from the position of 282 mm to the position of 283 mm relative to an end of the positive electrode plate in the fabrication of the cylindrical battery described above.

(Battery 3)

A battery 3 was fabricated in the same manner as the battery 1 except that the positive electrode material mixture layer was peeled off from the surface of the positive electrode current collector opposite to the surface thereof connected to the lead such that a portion where the positive electrode current collector was exposed had a width of 4 mm from the position of 280 mm to the position of 284 mm relative to an end of the positive electrode plate in the fabrication of the cylindrical battery described above.

(Battery 4)

A battery 4 was fabricated in the same manner as the battery 1 except that the positive electrode material mixture layer was peeled off from the surface of the positive electrode current collector opposite to the surface thereof connected to the lead such that a portion where the positive electrode current collector was exposed had a width of 6 mm from the position of 279 mm to the position of 285 mm relative to an end of the positive electrode plate in the fabrication of the cylindrical battery described above.

(Battery 5)

A battery 5 was fabricated in the same manner as the battery 1 except that the positive electrode material mixture layer was peeled off from the surface of the positive electrode current collector opposite to the surface thereof connected to the lead such that a portion where the positive electrode current collector was exposed had a width of 8 mm from the position of 278 mm to the position of 286 mm relative to an end of the positive electrode plate in the fabrication of the cylindrical battery described above.

(Battery 6)

A battery 6 was fabricated in the same manner as the battery 1 except that the positive electrode material mixture layer was peeled off from the surface of the positive electrode current collector opposite to the surface thereof connected to the lead such that a portion where the positive electrode current collector was exposed had a width of 12 mm from the position of 276 mm to the position of 288 mm relative to an end of the positive electrode plate in the fabrication of the cylindrical battery described above.

(Battery 7)

A battery 7 was fabricated such that the positive electrode material mixture layer was not peeled off from the surface of the positive electrode current collector opposite to the surface thereof connected to the lead in the fabrication of the cylindrical battery described above.

In each of the batteries 1-7, assembly and liquid insertion were performed, and 20 cells of each of the batteries 1-7 were fabricated. For each of these batteries, an OCV failure rate was measured in the following manner.

<Measurement of OCV Failure Rate>

In an atmosphere of 25° C., each of the batteries 1-7 was charged to a battery voltage of 4.2 V at a constant current of 1.4 A, and then was left for 24 hours in an atmosphere of 45° C. Thereafter, the battery voltage was measured in an atmosphere of 25° C. Batteries having battery voltages of 4.0 V or less were assumed to be failed, and the rate of occurrence of failures was obtained.

Subsequently, the battery capacity was measured in the following manner.

<Measurement of Battery Capacity>

In an atmosphere of 25° C., each of the batteries 1-7 was charged to a voltage of 4.2 V at a constant current of 1.4 A, was charged to a current of 50 mA at a constant voltage of 4.2 V, and then was discharged to a voltage of 2.5 V at a constant current of 0.56 A. The capacity at this time was measured.

Then, a crush test was conducted on each of the batteries 1-7 and results on the test were obtained in the following manner.

<Crush Test>

First, each of the batteries 1-7 was charged to 4.25 V at a constant current of 1.45 A, and then was charged to a current of 50 mA at a constant voltage. Then, a round bar with a diameter of 6 mm was brought into contact with each of the batteries 1-7 at a battery temperature of 30° C., and was moved toward the center axis of the battery at a speed of 0.1 mm/sec. In this manner, each of the batteries 1-7 was crushed. The amount of deformation along the depth of the battery at the time of occurrence of a short-circuit in each of the batteries was measured with a measurement sensor. Results of the crush test on each of the batteries 1-7 are shown in Table 1 below.

Table 1 shows results of the “OCV failure rate,” the “battery capacity,” and the “amount of deformation at the occurrence of short-circuit” in the crush test for each of the batteries 1-7.

TABLE 1

| | | Battery Capacity | Short-circuit Depth |
|---|---|---|---|
| | OCV Failure Rate | [Ah] | [mm] |
| Battery 1 | 0/20 | 2.9 | 13 |
| Battery 2 | 0/20 | 2.9 | 12 |
| Battery 3 | 0/20 | 2.9 | 12 |
| Battery 4 | 0/20 | 2.9 | 10 |
| Battery 5 | 0/20 | 2.9 | 5 |
| Battery 6 | 0/20 | 2.8 | 12 |
| Battery 7 | 3/20 | 2.9 | 8 |

### Example 2 and Comparative Example 2

### Battery 8

A positive electrode plate was formed in the same manner as in Example 1, except that attachment of a lead to the negative electrode plate was performed in a different manner as follows.

Peeling was performed from the surface of the negative electrode current collector connected to the lead such that a portion where the negative electrode current collector was exposed had a width of 6 mm from the position of 372 mm to the position of 378 mm relative to an end of the negative plate in the length direction, and from the surface of the negative electrode current collector opposite to the surface thereof connected to the lead such that a portion where the negative electrode current collector was exposed had a width of 2 mm from the position of 374 mm to the position of 376 mm relative to the end of the negative plate. At this time, the load was located at an end of the positive electrode such that the lead was located at the innermost portion. The positive electrode surface facing the negative electrode lead position was insulated by a polypropylene adhesive tape in order to prevent lithium deposition. Except for these processes, a battery 8 was fabricated in the same manner as the battery 1.

(Battery 9)

A battery 9 was fabricated in the same manner as the battery 8 except that the negative electrode material mixture layer was peeled off from the surface of the negative electrode current collector opposite to the surface thereof connected to the lead such that a portion where the negative electrode current collector was exposed had a width of 6 mm from the position of 372 mm to the position of 378 mm relative to an end of the negative electrode plate.

(Battery 10)

A battery 10 was fabricated in the same manner as the battery 8 except that the negative electrode material mixture layer was peeled off from the surface of the negative electrode current collector opposite to the surface thereof connected to the lead such that a portion where the negative electrode current collector was exposed had a width of 10 mm from the position of 370 mm to the position of 380 mm relative to an end of the negative electrode plate.

(Battery 11)

A battery 11 was fabricated in the same manner as the battery 8 except that the negative electrode material mixture layer was not peeled off from the surface of the negative electrode current collector opposite to the surface thereof connected to the lead.

As in Example 1, Table 2 below show results of the “OCV failure rate,” the “battery capacity,” and the “amount of deformation at the occurrence of short-circuit” in the crush test for each of the batteries 8-11.

TABLE 2

| | | Battery Capacity | Short-circuit Depth |
|---|---|---|---|
| | OCV Failure Rate | [Ah] | [mm] |
| Battery 8 | 0/20 | 2.8 | 13 |
| Battery 9 | 0/20 | 2.8 | 6 |
| Battery 10 | 0/20 | 2.7 | 11 |
| Battery 11 | 1/20 | 2.8 | 6 |

Examples 1 and 2 and Comparative Examples 1 and 2 will now be described in detail with reference to Tables 1 and 2.

As clearly shown in Tables 1 and 2, in the batteries 7 and 11, the OCV failure rates are higher than those in the other batteries. This is because of the following reasons. Since the mixture layer is formed on the surface opposite to the surface connected to the lead, the material mixture is peeled off with a shock in welding the lead (which is ultrasonic welding for the positive electrode and resistance welding for the negative electrode), and enters the electrode group, thereby causing a short-circuit. In particular, a high failure rate in the positive electrode is considered to be because the positive electrode active material is hard, and thus, easily penetrates the separator under an internal pressure of the electrode group to cause a short-circuit.

It was found that in the batteries 5, 7, 9, and 11, short-circuits are caused by crush at positions shallower than those in the other batteries. These batteries at the time of occurrence of short-circuits were disassembled and analyzed. Then, it was observed that in each of the batteries 5 and 7, the electrode plate bends at an acute angle near the positive electrode lead connection portion, and penetrates the separator to come into collision with the negative electrode, and in each of the batteries 9 and 11, the electrode plate comes into collision with the positive electrode in the same manner near the negative electrode lead connection portion to cause a short-circuit. Similarly, the batteries 1-4,6,8, and 10 at the time of occurrence of short-circuits were disassembled. Then, it was observed that the electrode plate bends at positions Y, Z, and Z′ shown in FIGS. 4 and 5 near the lead connection portions, but destruction of the outer case or breakage of the electrode plate itself causes a short-circuit.

The batteries 6 and 10 show the tendency of a decrease in the battery capacity, as compared to the other batteries. This is because an increase in the area from which the mixture layer is peeled off on the surface of each of the opposing positive and negative electrode lead connection portions causes the amount of the active material to relatively decrease, and thus, the capacity decreases. The capacities of the batteries 8-11 are smaller than those of the batteries 1-7 because of the following reasons. The position to which the lead is attached on the negative electrode is at the middle potion in the length direction thereof, and thus, a portion of the positive electrode active material which should originally operate is insulated by a tape and does not operate, thereby causing a decrease in the capacity.

### INDUSTRIAL APPLICABILITY

As described above, the present disclosure may be useful for devices such as household power supplies with, for example, higher energy density, power supplies to be installed in automobiles, and power supplies for large tools.

### DESCRIPTION OF REFERENCE CHARACTERS

1 battery case
2 sealing plate
3 gasket
4 positive electrode
4L positive electrode lead
5 negative electrode
5L negative electrode lead
6 separator (porous insulating layer)
7a upper insulating plate
7b lower insulating plate
8 electrode group
4A positive electrode current collector
4B positive electrode material mixture layer
5A negative electrode current collector
5B negative electrode material mixture layer
9 mixture layer
10 current collector
11 lead
13 exposed portion
14 exposed portion

1. An electrode plate for a nonaqueous electrolyte secondary battery, the electrode plate comprising:
a current collector made of metal foil in the shape of a band;
a mixture layer containing an active material and provided on each surface of the current collector; and
an extension lead connected to the current collector, wherein
the current collector has an exposed portion having first and second surfaces on each of which the mixture layer is not provided,
the exposed portion extends perpendicularly to a longitudinal direction of the current collector,
the extension lead is connected to the first surface of the exposed portion, and
a portion of the first surface on which the mixture layer is not provided has a width larger than that of a portion of the second surface on which the mixture layer is not provided.

2. The electrode plate of claim 1, wherein two ends of the mixture layer facing the exposed portion on the second surface are located at positions corresponding to positions on the first surface on which the exposed portion is not provided.

3. The electrode plate of claim 2, wherein a portion of the second surface on which the mixture layer is not provided has a width smaller than that of the extension lead vertical to the longitudinal direction of the current collector.

4. The electrode plate of claim 3, wherein two ends of the mixture layer facing the exposed portion on the second surface are located at positions corresponding to positions on the first surface on which the extension lead is provided.

5. The electrode plate of claim 1, wherein
the current collector is aluminum foil, and
the active material is a positive electrode active material.

6. A nonaqueous electrolyte secondary battery, comprising an electrode case enclosing a nonaqueous electrolyte and an electrode group in which a positive electrode plate and a negative electrode plate are wound with a porous insulating layer interposed therebetween, wherein
at least one of the positive electrode plate and the negative electrode plate is the electrode plate of claim 1.
